(19) United States
(12) Patent Application Publication
(10) Pub. No.: US 2005/0103187 A1
(43) Pub. Date: May 19, 2005

(54) Music retrieval system for joining in with the retrieved piece of music

(76) Inventor: Maarten Peter Bodlaender, Eindhoven (NL)

Correspondence Address: Corporate Patent Counsel;Philips Electornics North America Corporation, P O Box 3001, Briarcliff Manor, NY, 10510, US

(21) Appl. No.: 10/502,153

(22) PCT Filed: Jan. 15, 2003
(86) PCT No.: PCT/IB03/00085

(30) Foreign Application Priority Data
Jan. 24, 2002 (EP) 02075294.5

(51) Int. Cl. G10H 1/40

(52) U.S. Cl. 84/609; 84/611

(57) ABSTRACT

The invention relates to a music retrieval system comprising input means (210) for inputting user data (310) representative of music, memory means (220) for storing pieces of music, retrieval means (230) for retrieving a desired piece of music (330) in accordance with the user input data (310) upon finding a match between a particular one of the pieces of music stored in the memory means (220) and the user input data (310), and output means (250) for reproducing at least a fraction of the retrieved piece of music. According to the invention, the system further comprises output control means (240) determining, from the user input data (310), a current position (360) within the retrieved piece of music (330), said output control means being adapted to cause a start (370) of the fraction (380) of the retrieved piece of music to substantially coincide with said position (360). The invention also relates to a method of retrieving music suitable for implementing the disclosed music retrieval system.

The invention relates to a music retrieval system comprising input means for inputting user data representative of music, memory means for storing pieces of music, retrieval means for retrieving a desired piece of music in accordance with the user input data upon finding a match between a particular one of the pieces of music stored in the memory means and the user input data, and output means for reproducing at least a fraction of the retrieved piece of music.

The invention also relates to a method of retrieving music, the method comprising the steps of inputting user data representative of music, retrieving a desired piece of music in accordance with the user input data upon finding a match between a particular one of stored pieces of music and the user input data, and reproducing at least a fraction of the retrieved piece of music.

An embodiment of such a system is known from JP-2001075985. The music retrieval device disclosed in this document is capable of selecting a piece of music in a comparatively short time even without knowing a music title. The only input the system needs is singing or humming a part of music. Particularly, the music retrieval device includes display means to display results of searching the piece of music which matches with singing or humming of the part of music inputted from voice input means. Furthermore, the device reproduces a fraction of the searched piece of music corresponding to the singing or humming earlier inputted from voice input means. Reproducing of the corresponding fraction of the searched piece of music starts automatically when only one matching piece of music is found. The known device includes a microprocessor (CPU) which sends the results of searching the piece of music to the display means and carries out music regeneration of the corresponding fraction of the searched piece of music.

The embodiment known from JP-2001075985 discloses a method of reproducing the fraction of music corresponding to the earlier inputted singing or humming. According to the embodiment, a user first sings or hums remembered music and further listens to the fraction of music reproduced by the device. In that way, the described embodiment does not allow the user to continue further singing or humming without further interrupting the user to listen to the corresponding fraction of music reproduced from the beginning by the device. The music retrieval systems known in the prior art are developed to improve retrieval of the music and are not convenient enough for use.

It is an object of the invention to provide a music retrieval system of the kind defined in the opening paragraph which reproduces a retrieved piece of music in a more intelligent and user-friendly manner.

The object of the present invention is realized in that the system comprises output control means determining, from the user input data, a current position within the retrieved piece of music, said output control means being adapted to cause a start of the fraction of the retrieved piece of music to substantially coincide with said position.

The user may continue singing, humming or whistling while the system is retrieving the desired piece of music. Subsequently, the system determines the current position within the retrieved piece of music which the user is currently singing, humming or whistling. Thus, the system identifies the start of the fraction of the retrieved piece of music which coincides with the determined position and further reproduces that fraction. In other words, the system anticipates and reproduces the fraction within the retrieved piece of music which will match with a further inputted user data. The system recognizes a song or other piece of music which the user is singing, humming or whistling and joins in with it. The user can continue singing, humming or whistling and listen to the reproduced music at the same time.

According to an embodiment of the present invention, the system further comprises the output control means arranged to determine at least one parameter from the user input data and adapt the reproduction of the fraction of the retrieved piece of music with respect to said parameter. In that way, the system modifies reproduction of the retrieved music depending on parameters like pitch, tempo, volume etc. For example, the system determines from the user input data the tempo of the user's singing, humming or whistling. The system further reproduces the fraction of the retrieved piece of music with the determined tempo of the user's singing, humming or whistling.

In another embodiment of the present invention, if the user was singing, humming or whistling in a wrong way, the system facilitates correction by the user of his/her singing, humming or whistling in accordance with the retrieved piece of music. In one of the embodiments, the system first determines at least one first parameters from the user input data and at least one second parameter from the retrieved piece of music. The first and second parameters are parameters like pitch, tempo, volume etc. Thus, the second parameters are reference parameters of the correct reproduction of the retrieved piece of music. The system further compares at least one of the first parameters with at least one of the second parameters. If at least one of the first parameters is different from at least one of the second parameters, the system is arranged to start reproducing the fraction of the retrieved piece of music with at least one of the further parameters which is similar to at least one of the first parameters. Subsequently, the system reproduces the fraction of the retrieved piece of music with at least one of the further parameters, e.g. the tempo, being gradually corrected to the corresponding one of the second parameters. Finally, the system reproduces the fraction of the retrieved piece of music correctly, with the second parameters. In that way, the system helps the user to sing or the like in accordance with the retrieved piece of music.

In another embodiment, the system modifies the volume of reproducing the music. The fraction of the retrieved piece of music is reproduced with a first lower volume gradually increasing to a second higher volume, for a finite period of time. The second volume can be adjusted to the volume of user input. Thus, the user is not affected by an unexpected reproduction of the retrieved piece of music with the high volume.

In a further embodiment of the present invention, the system further comprises means for visually presenting at least one of the retrieved pieces of music. Said means can be easily implemented with a display device.

The object of the present invention is also realized in that a method of the invention comprises the steps of determining, from the user input data, a current position within the retrieved piece of music, and causing a start of the fraction of the retrieved piece of music to substantially coincide with said position.

The method describes steps of operation of the music retrieval system.

These and other aspects of the invention will be further elucidated and described with reference to the accompanying drawings, wherein:

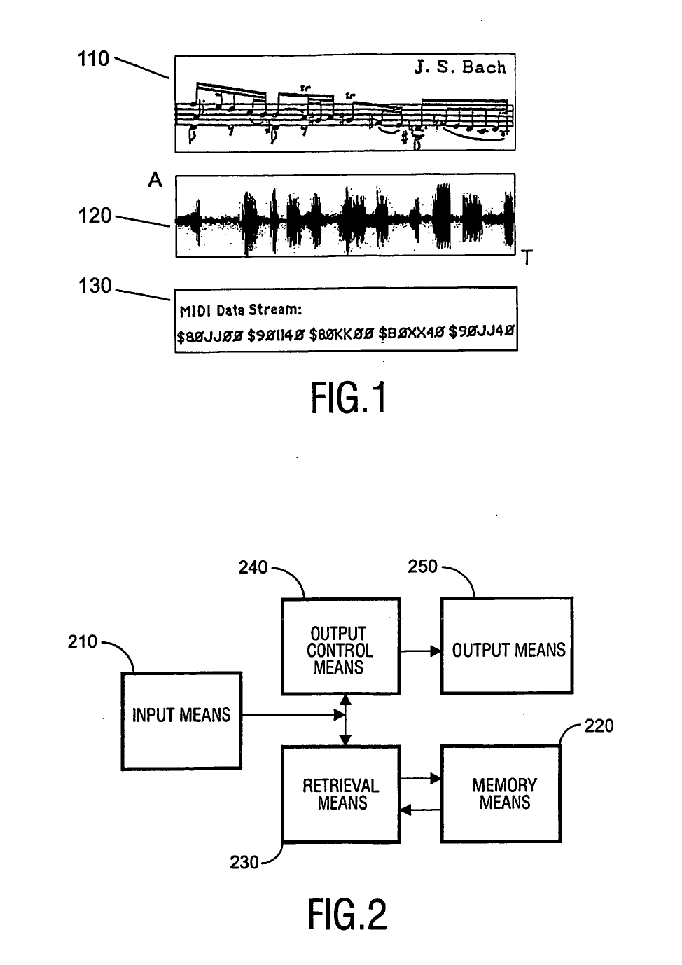

FIG. 1 (prior art) shows examples of a frequency spectrum of a user input, the fraction of the piece of music to be retrieved in accordance with the user input and a MIDI data stream representative of said user input;

FIG. 2 shows a functional block diagram of the music retrieval system of the present invention;

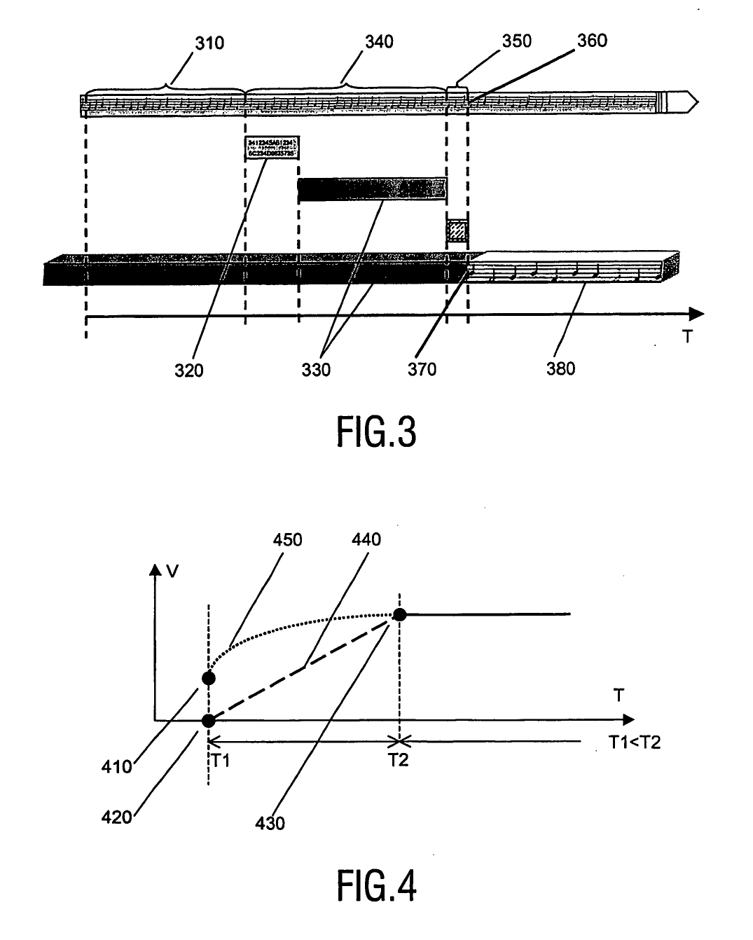

FIG. 3 shows a diagram illustrating the method and operation of the system of the present invention;

FIG. 4 shows an embodiment of the system of the present invention, wherein one of the parameters of reproducing the fraction of the retrieved piece of music is modified depending on one of the parameters determined from the user input data.

FIG. 1 shows examples of a frequency spectrum 120 of a user input, the fraction of the piece of music 110 to be retrieved in accordance with the user input and a MIDI data stream 130 representative of said user input, as is known in the prior art. The examples illustrate the piece of music 110 which the user is singing, humming or whistling and would like the system to retrieve. The user input to the system may be a sound signal that needs to be transformed into digital data. It is known in the prior art to analyze the frequency spectrum of the inputted sound signal 120 for obtaining said digital data. The MIDI (Musical Instrument Digital Interface) protocol can be used to provide a standardized means to provide the user input and the pieces of music as digital electronic data. Thus, the user input is converted to the MIDI data stream 130 as the digital data using the MIDI protocol. Other known digital music standards, like MPEG-1 Layer 3, Advanced Audio Coding (AAC), may be used as well.

FIG. 2 shows a functional block diagram of the music retrieval system of the present invention. The system includes input means 210 for inputting the user data representative of music, memory means 220 for storing the pieces of music, retrieval means 230, output controls means 240 and output means 250 for reproducing at least the fraction of the retrieved piece of music.

The user can provide the input to the system through humming, whistling, singing or manipulating a particular key of a keyboard, or drumming a rhythm with his or her fingers, etc. The input means 210 may comprise a microphone for inputting a user voice, an amplifier of the user voice and an A/D converter for transforming the user input to the digital data. The input means may also comprise a keyboard for inputting user commands or the like. Many techniques of converting the user input to the digital data are already known in the prior art. One of such techniques is proposed in Patent JP-09138691. According to this document, user voice data are inputted via a microphone and converted to pitch data and tone length data constituting the voice data with the input means. The pitch data and tone length data can be further converted to frequency data and tone length data.

According to the present invention, the memory means 220 are adapted to store the pieces of music. Particularly, the memory means can be designed for storing respective reference data representing reference sequences of musical notes of respective ones of musical themes, as is known from document WO 98/49630. The retrieval means 230 are arranged to retrieve a desired piece of music in accordance with the user input data upon finding a match between a particular one of the pieces of music stored in the memory means 220 and the user input data. The output means may comprise a D/A converter for transforming at least the fraction of the retrieved piece of music to an output sound signal, an amplifier of the output sound signal and a speaker for outputting said signal.

The output control means 240 are coupled to the retrieval means 230, input means 210 and output means 250. The output control means determine, from the user input data, a current position within the retrieved piece of music in which the user is currently humming, whistling or signing. There are at least three possibilities of determining said current position by the output control means:

a) After inputting first user data for retrieving the desired piece of music, the output control means of the system start receiving second user input data from the input means. In that way, the output control means are provided with the recently inputted user data. When the desired piece of music is retrieved by the retrieval means, the output control means immediately start comparing the second inputted user data with the retrieved piece of music in order to determine the start of the fraction of the retrieved piece of music that will match with further inputted user data. If the start of said fraction is found, the output control means provide the output means with said fraction, and the output means further reproduce that fraction.
b) The output control means start receiving the second user data when the desired piece of music is already retrieved by the retrieval means.
c) The output control means are arranged to estimate the current position by analyzing the first user data, without receiving any further user data. In other words, the output control means anticipate the position in which the user is singing, humming, whistling at the moment when the desired piece of music is retrieved, but do not receive any further user input data. The only user input data the system receives are the first user data needed for retrieving the desired piece of music. Such anticipation of the current position can be implemented by using a specific algorithm. For example, the system may include a timer arranged to count a time of retrieving the desired piece of music, to estimate approximately an average time necessary to determine the current position. When the position within the retrieved piece of music at which the user was singing, humming, whistling, etc. is determined from the first user data, the system adds to said position the time of retrieving the desired piece of music and the average time of determining the current position. In that way, the system approximately determines the current position. The accuracy of determining the current position will be relatively high, if the time of retrieving the desired piece of music is not more than a few seconds.

When the system has already started reproducing the fraction of the retrieved piece of music, the output control means of the system may be adapted to continue keeping track of the current position within the retrieved piece of music in which the user is currently singing, humming, whistling etc. In that way, the system can react to a user behavior. For example, the system could stop reproducing the fraction of the retrieved piece of music or the like, if the further inputted user data did not match with the reproduced fraction of the retrieved piece of music.

The output control means 240 can be implemented with a microcontroller unit or a software product that will be apparent to those skilled in the art.

The method of the present invention and the operation of the system will be further elucidated with reference to FIG. 3. A horizontal time axis is shown for illustrating a sequence of steps of the method. The user input 310 to the system may be singing, humming, whistling or the like as is elucidated above. The method comprises the steps of inputting user data 310 representative of music, and retrieving a desired piece of music 330 in accordance with the user input data 310 upon finding a match between a particular one of stored pieces of music and the user input data 310. The method further comprises the steps of determining, from the user input data 340 or 350, a current position 360 within the retrieved piece of music 330, and causing a start 370 of the fraction 380 of the retrieved piece of music 330 to substantially coincide with said position 360. In a subsequent step, the fraction 380 of the retrieved piece of music is reproduced.

The current position can be determined from the user input data 340 or 350 by the output control means as is described above in case “a” or “b”, respectively. The system may not exactly determine said current position within the retrieved piece of music. In other words, the current position 360 and the start of the fraction 370 may not exactly coincide. Therefore, the system may start reproducing the fraction of the retrieved piece of music at the position which is earlier or later than the position in which the user is currently singing, whistling or humming. However, currently known music retrieval devices retrieve the music quite fast and the user would not be confused if the described situation occurred.

According to an embodiment of the present invention, the system further comprises the output control means arranged to determine at least one parameter from the user input data and adapt the reproduction of the fraction of the retrieved piece of music with respect to said parameter. In that way, the system modifies reproduction of the retrieved music depending on parameters like pitch, tempo, volume, etc. For example, the system determines, from the user input data, the tempo of the user's singing, humming or whistling. The system further reproduces the fraction of the retrieved piece of music with the determined tempo of the user's singing, humming or whistling. In another example, the system is arranged to reproduce the fraction of the retrieved piece of music with a volume close or equal to the volume of the user input.

In another embodiment of the present invention, if the user was singing, humming or whistling in a wrong way, the system facilitates correction by the user of his/her singing, humming or whistling in accordance with the retrieved piece of music. In one of the embodiments, the system first determines at least one first parameter from the user input data and at least one second parameter from the retrieved piece of music. The first and second parameters are parameters like pitch, tempo, volume etc. Thus, the second parameters are reference parameters of the correct reproduction of the retrieved piece of music. The system further compares at least one of the first parameters with at least one of the second parameters. If at least one of the first parameters is different from at least one of the second parameters, the system is arranged to start reproducing the fraction of the retrieved piece of music with at least one of the further parameters which is similar to at least one of the first parameters. Subsequently, the system reproduces the fraction of the retrieved piece of music with at least one of the further parameters, e.g. the tempo, being gradually corrected to the corresponding one of the second parameters. Finally, the system reproduces the fraction of the retrieved piece of music correctly, with the second parameters. In that way, the system helps the user to sing or the like in accordance with the retrieved piece of music.

Referring now to FIG. 4, an embodiment of the system of the present invention is shown, wherein one of the parameters of reproducing the fraction of the retrieved piece of music is modified depending on one of the parameters determined from the user input data. In this embodiment, said parameter is the volume of reproducing the music. A vertical and a horizontal axis of a graph shown in FIG. 4 indicate said volume of reproducing the music and the time, respectively. The fraction of the retrieved piece of music is reproduced with a first lower volume 410 or 420 gradually increasing to a second higher volume 430. The system starts reproducing at the moment T1, increasing the volume of reproducing the music is stopped at the moment T2. The volume of reproducing the music can be increased linearly 440 or otherwise 450. The second volume 430 can be adjusted to the volume of user input. Thus, the user is not affected by the reproduction of the retrieved piece of music with the high volume which may be unexpected or not suitable for the user to continue singing, whistling or humming.

In a further embodiment of the present invention, the system further comprises means for visually presenting at least one of the retrieved pieces of music. Said means can be easily implemented with a display device, as is known in the prior art.

In a further embodiment of the invention, the memory means of the system store recited poetry, the system retrieves a desired piece of poetry upon inputting to the system the user data representative of prose, verse, poem, etc. The user may remember some fraction of the piece of poetry or the like, and may be interested to know an author, name or other data about it. In this embodiment, the system is designed to retrieve such data upon a user request.

The object of the invention is achieved in that the system, method and various embodiments are provided with reference to the accompanying drawings. The system recognizes a song or other piece of music which the user is singing, humming or whistling and joins in with it. The user can continue singing, humming or whistling and listen to the reproduced music at the same time.

The various program products may implement the functions of the system and method of the present invention and may be combined in several ways with the hardware or located in different devices. A “computer program” is to be understood to mean any software product stored on a computer-readable medium, such as a floppy disk, downloadable via a network, such as the Internet, or marketable in any other manner. Variations and modifications of the described embodiment are possible within the scope of the inventive concept.

1. A music retrieval system comprising input means (210) for inputting user data (310) representative of music, memory means (220) for storing pieces of music, retrieval means (230) for retrieving a desired piece of music (330) in accordance with the user input data (310) upon finding a match between a particular one of the pieces of music stored in the memory means (220) and the user input data (310), output means (250) for reproducing at least a fraction of the retrieved piece of music, the system being characterized in that the system comprises
output control means (240) determining, from the user input data (310), a current position (360) within the retrieved piece of music (330), said output control means being adapted to cause a start (370) of the fraction (380) of the retrieved piece of music to substantially coincide with said position (360).

2. The system of claim 1, wherein said output control means (240) are further arranged to determine at least one parameter from the user input data and adapt the reproduction of the fraction of the retrieved piece of music with respect to said parameter.

3. The system of claim 2, wherein said parameter is at least one of the following parameters: pitch, tempo and volume.

4. The system of claim 2, wherein said parameter is the volume, and the fraction of the retrieved piece of music is reproduced with a first lower volume gradually increasing to a second higher volume (430), for a finite period of time, the second volume (430) being adjusted to the volume of user input.

5. The system of claim 1 further comprising means for visually presenting at least one of the retrieved pieces of music.

6. A method of retrieving music, the method comprising the steps of inputting user data (310) representative of music, retrieving a desired piece of music (330) in accordance with the user input data (310) upon finding a match between a particular one of stored pieces of music and the user input data (310), and reproducing at least a fraction of the retrieved piece of music, the method being characterized in that it comprises the steps of
determining, from the user input data (310), a current position (360) within the retrieved piece of music (330), and causing a start (370) of the fraction (380) of the retrieved piece of music to substantially coincide with said position (360).

7. The method of claim 6 further comprising the steps of determining at least one parameter from the user input data and adapting the reproduction of the fraction of the retrieved piece of music with respect to said parameter.

8. The method of claim 7, wherein said parameter is at least one of the following parameters: pitch, tempo and volume.

9. The method of claim 7, wherein said parameter is the volume, and the fraction of the retrieved piece of music is reproduced with a first lower volume gradually increasing to a second higher volume (430), for a finite period of time, the second volume (430) being adjusted to the volume of user input.

10. The method of claim 6 further comprising a step of visually presenting at least one of the retrieved pieces of music.

11. A computer program product enabling a programmable device when executing said computer program product to function as the system defined in claim 1.
